(19) United States
(12) Patent Application Publication
(10) Pub. No.: US 2007/0156482 A1
(43) Pub. Date: Jul. 5, 2007

(54) System and method for generating and providing priority information

(75) Inventor: Ramin Bagheri, Schwetzingen (DE)

Correspondence Address: KENYON & KENYON LLP, 1500 K STREET N.W., WASHINGTON, DC, 20005, US

(73) Assignee: SAP AG

(21) Appl. No.: 11/319,239

(22) Filed: Dec. 29, 2005

(51) Int. Cl. G05B 19/418; G06F 15/02; G06F 9/46

(52) U.S. Cl. 705/8; 705/9

(57) ABSTRACT

In a procurement system and method, a processor may receive a plurality of purchase order (P.O.) requests, extract data from fields of each of the P.O. requests, based on the extracted data, assign each of the P.O. requests to a corresponding priority category, and output a list of the P.O. requests and data indicating their corresponding priority categories.

### BACKGROUND

Entities, e.g., individual people or business entities, often have at a given time numerous tasks to perform, but the entity is often incapable of performing all of the tasks simultaneously. The entity therefore prioritizes the tasks to determine an order in which to perform the tasks. However, determining priority of tasks can waste much time, time which can otherwise be used to perform the tasks themselves. To save time, especially if the number of tasks to perform becomes very large, the entity often performs the tasks on a first come first served basis, where the entity first performs a task that is first determined to be required, requested, or desired, without performing a prioritization analysis. Disregarding priorities of the tasks often results in failure to meet deadlines for some tasks and/or non-performance of some tasks.

In particular, a business entity often has numerous departments, where each department performs its assigned task, so that the departments in combination complete a project. An example is where departments require certain items. The departments determine what is needed and forward a Purchase Order (P.O.) request to a purchasing department. The purchasing department receives numerous P.O. requests, determines the suppliers from which the items are to be ordered, and sends P.O.'s to the suppliers requesting the items. The purchasing department often receives an extremely large number of P.O. requests and cannot send P.O.'s for all of the received P.O. requests the same day that the purchasing department receives the P.O. requests.

In this instance, the purchasing department cannot disregard prioritization of the P.O. requests and send P.O.'s to suppliers in the order in which the purchasing department receives the P.O. requests. Especially since the purchasing department receives P.O. requests from numerous requesting departments, receipt by the requesting departments of some first items may be required before receipt by the requesting department of some second items, even though the P.O. requests for the second items are received by the purchasing department before receipt of the P.O. requests for the first items. Furthermore, even if the dates by which receipt of the items is required are in the same order in which the P.O. requests are placed, it is often desirable to send P.O.'s in a different order, e.g., when lead times (the time it usually takes between the transmittal to a supplier of a P.O. for a particular item and receipt of the item from the supplier) vary. For example, if receipt of two different items is required on the same day, it may be required to send a P.O. for a first one of the two items before sending a P.O. for a second one of the two items if the lead time of the first item is longer than the lead time of the second item.

Accordingly, if the purchasing department sends P.O.'s to suppliers in the order in which the purchasing department receives P.O. requests, and does not perform and disregards a prioritization analysis of the P.O. requests, the requesting departments will not receive many of the requested items in time.

Conventional applications assist in the management of P.O. requests and the transmittal of P.O.'s in response to such requests, but do not aid in the prioritization of the P.O. requests to help ensure that requested items are received in time.

### BRIEF DESCRIPTION OF THE DRAWINGS

FIG. 1 is a block diagram that illustrates example components of a system according to an example embodiment of the present invention.

FIG. 2 is a data flow diagram that illustrates an example procedure according to which priorities of queued P.O. requests may be indicated, according to an example embodiment of the present invention.

FIG. 3 illustrates a table that shows for each of a number of requested items example input data and a determined priority category to which a corresponding P.O. request may be assigned, according to an example embodiment of the present invention.

FIG. 4 is an example screenshot that illustrates an example table display, according to an example embodiment of the present invention.

### DETAILED DESCRIPTION

Embodiments of the present invention relate to a computer system and method that may perform a prioritization analysis on a queue of tasks to be performed by a user and may provide the user with priority information regarding the tasks to be performed. In particular, embodiments relate to a system and method that may receive P.O. requests, perform a prioritization analysis on the received P.O. requests, and output prioritization data for each of the received P.O. requests.

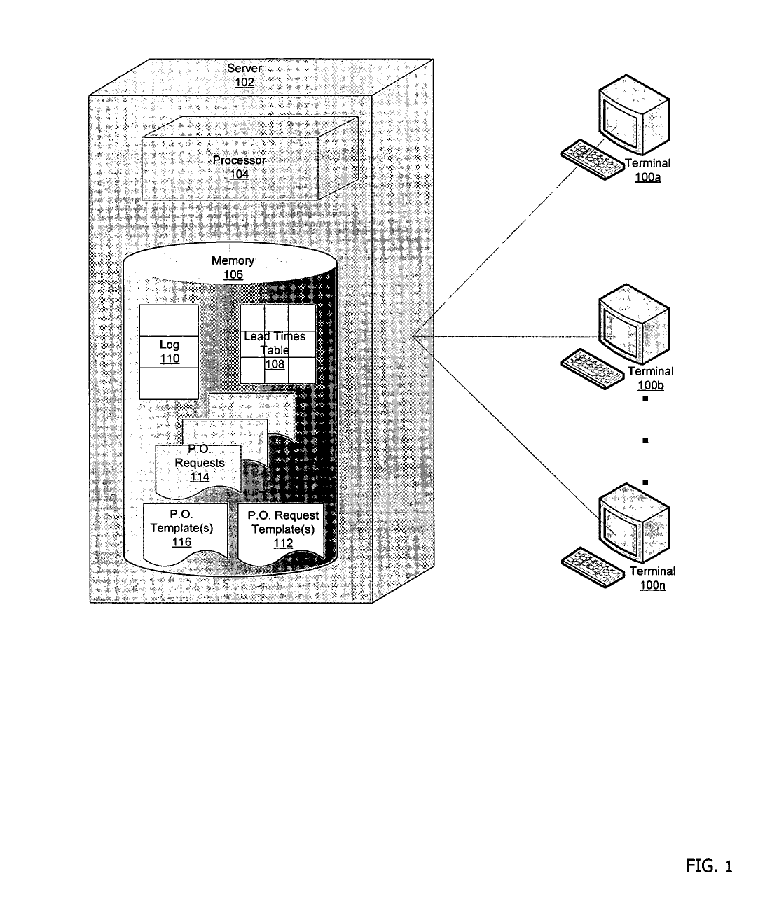

FIG. 1 is a block diagram that illustrates example components of a system according to an example embodiment of the present invention. A user may input task performance identifications and/or requests 114, (e.g., P.O. requests generated based on a P.O. request form template 112 stored in a memory 106), via an input device of a terminal 100. An input device may be, e.g., a keyboard, a touchpad, a mouse, and/or any other conventional input device. A processor 104 may receive the P.O. requests 114 and may store them in the memory 106. In one embodiment, the processor 104 and the memory 106 may be a local processor and memory of the input terminal 100. For example, the terminal 100 may be a Personal Computer (PC) and the processor 104 and memory 106 may be a PC processor and a PC memory of the PC 100. In an alternative embodiment, the processor 104 and memory 106 may be of a central server 102 to which a plurality of terminals 100a-n may be connected. According to this embodiment, the processor 104 may receive P.O. requests 114 from the terminals 100a-n and may store them in the memory 106.

For each of the received P.O. requests 114, the server 102 may determine a priority for generation and transmittal of a corresponding P.O., which may be generated based on a P.O. template 116 stored in the memory 106. The server 102 may make the priority determination based on data provided in, or together with submission of, the P.O. requests 114. For example, a user may input a P.O. request 114 that includes data indicating a date by which delivery of a requested item is required. The server 102 may determine the priority of the P.O. request based on the indicated required delivery date.

In one embodiment, the server 102 may consider an indicated lead time in combination with the indicated required delivery date to determine the priority of the P.O. request. According to this embodiment, the user who submits the P.O. request may also include in or with the P.O. request an estimated lead time for the requested item. Alternatively, the estimated lead time may be input separately, e.g., by the user who input the P.O. request or by another user.

For example, users of requesting departments may input P.O. requests 114 that each indicate a required delivery date for the requested items. For each of the P.O. requests 114, e.g., in response to an input request prompt by the server 102, a user of a purchasing department may input estimated lead dates for the items requested in the P.O. requests 114. Alternatively, a user, e.g., of the purchasing department, may input a table of items and their estimated lead dates. The server 102 may store the lead times table 108 in the memory 106. When the server 102 receives a P.O. request 114, the server 102 may match an item identified in the P.O. request 114 with an item in the table 108 to determine the estimated lead time for the requested item of the P.O. request.

In one embodiment of the present invention, the server 102 may determine estimated lead times for one or more items based on a lead times history, and may store the determined estimated lead times in the table 108. According to this embodiment, the server 102 may generate the lead times table 108. For example, the server 102 may store in the memory 106 a log 110 of all P.O.'s and the dates on which they were sent to suppliers. As the items are received from the suppliers, a user, e.g., of the requesting department, the purchasing department, or of a separate receiving department, may input information regarding the received items, including a date of receipt. The information regarding the received items may include data identifying the P.O.'s fulfilled by receipt of the items. For example, each P.O. may be assigned a P.O. number. The supplier(s) of the received items may include with the items an identification of the P.O. number of the P.O. for which the items were sent. When the user enters the date of receipt of the items, the user may also enter the P.O. number with which the received items are associated. For the received items, the server 102 may determine the lead time (a current actual lead time) based on the time difference between the date and/or time when the P.O. was sent and the date and/or time when the associated items were received (or a time when receipt of the items is logged).

In one embodiment, the server 102 may update the table 108 over time to include estimated lead times for additional items, and to change previously estimated lead times for items already included in the lead times table 108. For example, an actual lead time for a particular item may vary. On one occasion, the item might be received after 4 days from transmittal of the P.O., while on another occasion, the item might be received after 2 weeks from transmittal of the P.O. The server 102 may therefore average the determined actual lead times to determine the estimated lead time. For example, the server 102 may store, e.g., in the table 108, a number indicating the number of times a P.O. was sent for the item. For each transmission of a P.O. for the item, for each recordation of a receipt of the item, or, more generally, for each new application of the following formula, the server 102 may increment the number. The server 102 may then determine the updated estimated lead time, e.g., based on the following formula:
(([previously recorded estimated lead time]*[number−1])+[determined current lead time])/[number].
Other variations are permissible. For example, the server 102 may perform a weighted average that emphasizes estimated lead times of recently received items over items received in the distant past. Alternatively or in addition, the server 102 may determine whether the determined current lead time is an aberrant lead time and may disregard it if it is determined to be an aberrant lead time.

In an embodiment of the present invention, the server 102 may provide a user with a list of tasks to be performed, and for each task indicate its priority. For example, the server 102 may arrange in a table a list of P.O. requests 114, e.g., for which P.O.'s have not yet been generated and/or sent to suppliers, and may include in the table a column in which, for each listed P.O. request 114, priority information is provided. Alternatively, or in addition, the server 102 may list the P.O. requests 114 in an order that is in accordance with the determined priorities of the listed P.O. requests 114.

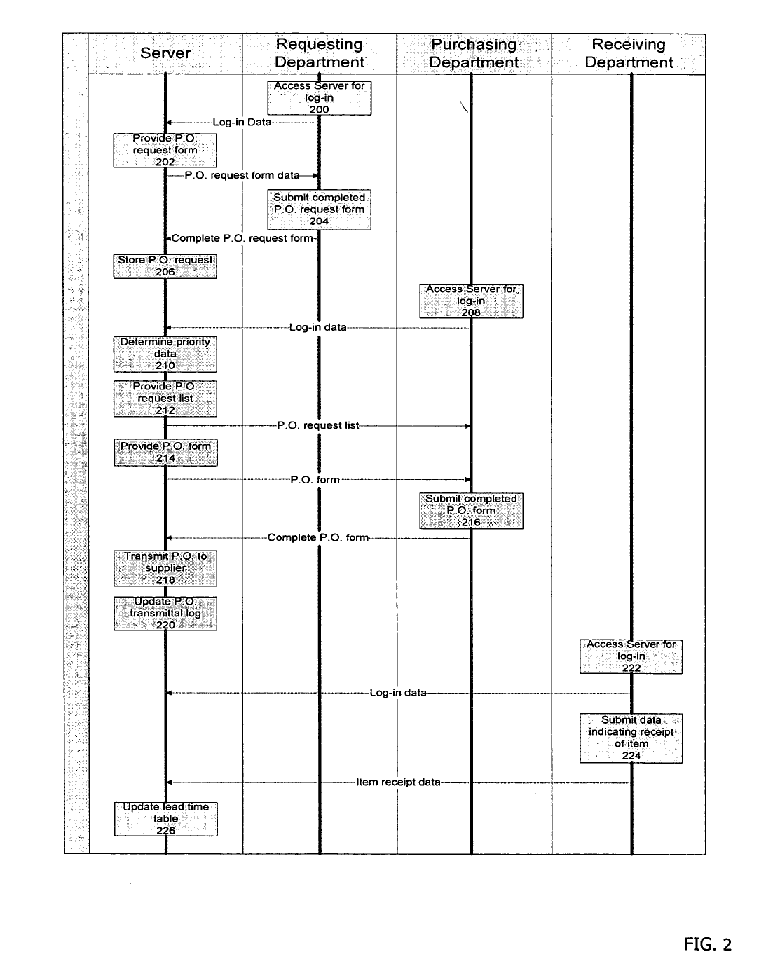

FIG. 2 is a data flow diagram that illustrates an example procedure in which a system and method of the present invention may aid in the submission of P.O. requests and the transmittal of P.O.'s. At 200, a first user may access the server 102 to log into the system. For example, the first user may be a member of a requesting department that may log into a portal page of a business entity that includes the requesting department, a purchasing department, and a receiving department. To do so, the first user may enter a portal page address or select an icon for contacting that address. At 202, the server 102 may provide the first user with data for display of an electronic form that is a copy of a stored P.O. request form template 112 stored in the memory 106. The server 102 may provide the electronic form to the first user in response to a request for the form, or automatically when it determines that the first user is of the requesting department. In one embodiment, a variety of P.O. request form templates 112 may be stored in the memory 106 for generating P.O. requests 114 for a variety of item types. Different templates 112 may include different fields, e.g., fill-in fields. The particular template 112 used may depend on selections by the first user indicating to the server 102 a particular item category for which the P.O. request 114 will be generated. At 204, the first user may fill in the fields and submit a completed form to the server. The user may fill in fields by selecting from a drop-down box, checking boxes, keying in the data, and/or by any other conventional manner by which to enter data. Such data may include, but is not limited to, an item description, a quantity, and/or a need date. At 206, the server 102 may store the received P.O. request 114 in the memory 106. 200 to 206 may be repeated numerous times for one or more users of the requesting department, such that the server 102 may receive and store numerous completed P.O. requests 114.

At 208, a second user, e.g., that is a member of the purchasing department, may access the server 102 to log into the system. At 210, the server 102 may determine priority data associated with the queued P.O. requests 114 that were previously received at 204. For example, 210 may be performed in response to a request for a list of P.O. requests 114. The priority data for a P.O. request 114 may be determined, e.g., based on a date by which the item(s) of the P.O. request 114 must be received and/or based on a lead time(s) associated with the requested items. To determine the date by which the item(s) must be received, the server 102 may extract data from a field of the completed P.O. request form 114 that is provided for receiving therein data indicating the required delivery date. To determine the lead times of the items, the server 102 may extract data from fields of the form that indicate the particular items that are being requested. The server 102 may then match the extracted data to data in the lead times table 108. For example, the data may be entered as a string which may be matched to a string of the stored lead times table 108. The lead times table 108 may include an estimated lead time for the items(s) of the P.O. request 114. If the item is not in the table 108, the server 102 may determine the priority data without considering a lead time. Alternatively, the server 102 may prompt the second user to provide an estimated lead time.

At 212, the server 102 may provide the second user with data for output, e.g., display, of a list of all of the queued P.O. requests 114, including and/or in accordance with the determined priority data.

At 214, e.g., in response to a request by the second user, the server 102 may provide the second user with data for display of an electronic form that is a copy of a stored P.O. template 116 stored in the memory 106. The second user may submit the request by selecting a listed P.O. request 114. In one embodiment, a variety of P.O. templates 116 may be stored in the memory 106 for generating P.O.'s for a variety of item types. Different templates 116 may include different fields, e.g., fill-in fields. The particular template 116 used may depend on the item category to which the item or items of the selected P.O. request 114 belongs. At 216, the second user may submit a completed P.O. form to the server 102. At 218, the server 102 may transmit the completed P.O. to a supplier. At 220, the server 102 may update a log 110 of P.O.'s and the times at which they were transmitted to suppliers to reflect the transmittal of the P.O. at 218.

In one example embodiment, instead of 216-218, the second user may transmit the P.O. to a supplier in any conventional manner, including mail, e-mail, facsimile, etc. The second user may submit to the server 102 a notification of transmittal of the P.O. to the supplier. At 220, the server 102 may update the log 110 to indicate transmittal of the P.O. and to indicate the time of transmittal as indicated by the second user, or the time at which the server 102 received notification from the second user of the transmittal of the P.O.

At 222, a third user may access the server 102 to log into the system. For example, the third user may be a member of the receiving department. At 224, the third user may submit data to the server 102 indicating receipt of an item from a supplier and the particular P.O. fulfilled by receipt of the item. At 226, the server 102 may compare the date and/or time of receipt with the date and/or time of transmittal of the corresponding P.O. as indicated in the stored log 110, and may accordingly update the lead times table 108. If the item is not listed in the lead times table 108, the server 102 may add a new lead time entry.

It will be appreciated that FIG. 2 and its description is provided by way of example only. For example, it will be appreciated that the users may log into the system via a single terminal, that a single user may log into the system for performance of all of the user steps, e.g., during a single log-in, that a local processor of the user terminal may be used instead of the server 102, and/or that the system capabilities may be accessed without accessing a portal page of the business entity. For example, locally stored program instructions may be loaded for execution by a local processor to perform the system steps.

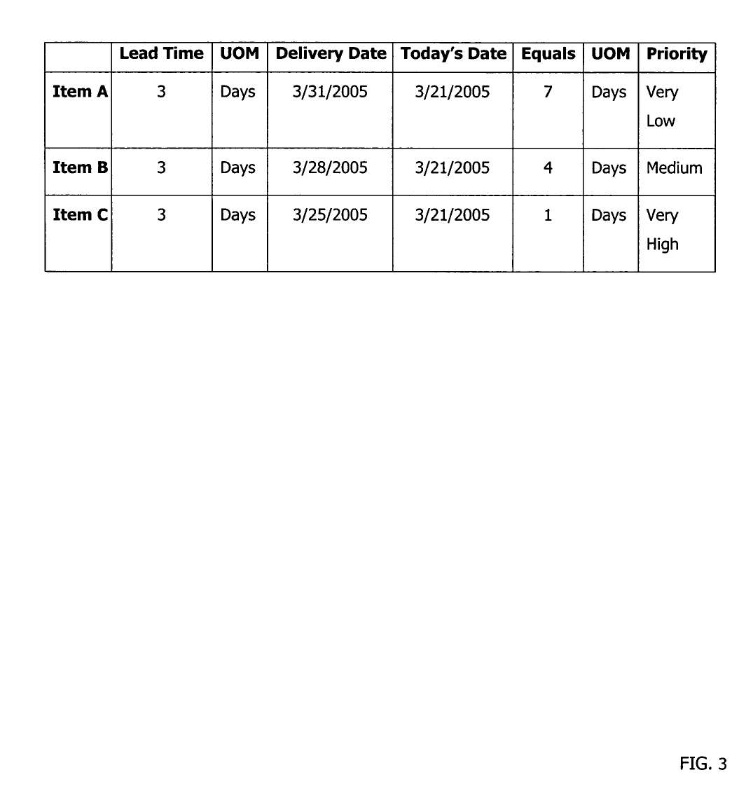

In an embodiment of the present invention, the server 102 may generate priority data for each of a plurality of P.O. requests 114 in a vacuum. For example, the server 102 may generate the priority data, e.g., based on the following formula:
[delivery date and/or time]−[current date and/or time]−[estimated lead time].
Depending on a result interval in which the result of the formula falls, the server 102 may assign a P.O. request 114 to a corresponding priority category. For example, days may be used as a unit of measure. The server 102 may assign all P.O. requests 114 for which priority calculation results are 2 days or less to a “very high” priority category, all P.O. requests 114 for which priority calculation results are between and including 3 and 5 days to a “medium” priority category, and all P.O. requests 114 for which priority calculation results are 6 days or more to a “very low” priority category. It will be appreciated that P.O. requests 114 may be assigned to additional categories, such as “low” and “very low,” instead of a single “low” category. If a P.O. request 114 is submitted to request a variety of items having different lead times and/or different delivery date requirements, in one example embodiment of the present invention, the server 102 may determine priority categories for each of the items and may assign the P.O. request 114 to the highest of the individual priority categories. Alternatively, where only the lead times are different, the server 102 may determine the priority category by plugging in the longest lead time into the formula provided above. Alternatively, for a single P.O. request 114, a number of entries may be provided in the list of P.O. requests. Each entry may indicate a priority of a corresponding item of the single P.O. request 114. Alternatively, the server 102 may divide the items having different priority parameters into separate P.O. requests 114. A table illustrating example input data and priority data output for P.O. requests 114 is shown in FIG. 3. According to this embodiment, all queued P.O. requests 114 may be assigned to the same priority category if the priority formula results calculated for them all fall within the same category interval.

In an alternative embodiment, the server 102 may generate priority data for a plurality of P.O. requests 114 by comparing priority parameter data of each of the queued P.O. requests 114 in comparison to priority parameter data of other ones of the queued P.O. requests 114. For example, after determining a result for each of the queued P.O. requests 114, the server 102 may determine a lowest result value (corresponding to a highest priority) and a highest result value (corresponding to a lowest priority), and may, for example, assign all P.O. requests 114 for which a calculated result value is within a top 25% of the interval between the lowest and highest result values to a “very low” priority category, all P.O. requests 114 for which a calculated result value is within a bottom 25% of the interval to a “very high” priority category, and all P.O. requests 114 for which a calculated result value is within a middle 50% of the interval to a “medium” priority category. It will be appreciated that other variations of ways in which to assign P.O. requests 114 to priority categories may be implemented, and further description is not necessary for an understanding of the present invention.

In an alternative embodiment, the server 102 may sort the P.O. requests 114 based on their corresponding calculated priority results, e.g., from lowest (highest priority) to highest (lowest priority), without assigning the P.O. requests 114 to particular priority categories.

In an embodiment of the present invention, the server 102 may consider other factors in addition to or instead of those described above. For example, requests by particular users or that originate from particular departments may be given higher priority than those by other users or that originate from other departments. In one example embodiment, the determined priority result values may be multiplied by a constant. The constant may vary depending on the particular user who submitted the P.O. request and/or the particular department from which the request originated. Accordingly, these and other factors may be considered, e.g., each factor being given different weight.

In one example embodiment, the particular factors used to determine the priority categories may customizable, e.g., according to user input. Additionally, in an embodiment of he present invention, for those factors that are used, the particular weights assigned to one or more of the factors may be customizable, e.g., according to user input.

In one example embodiment, one or more users may be given override authority such that user(s) may instruct the server 102 to assign a particular P.O. request 114 a particular priority status, regardless of priority calculation results.

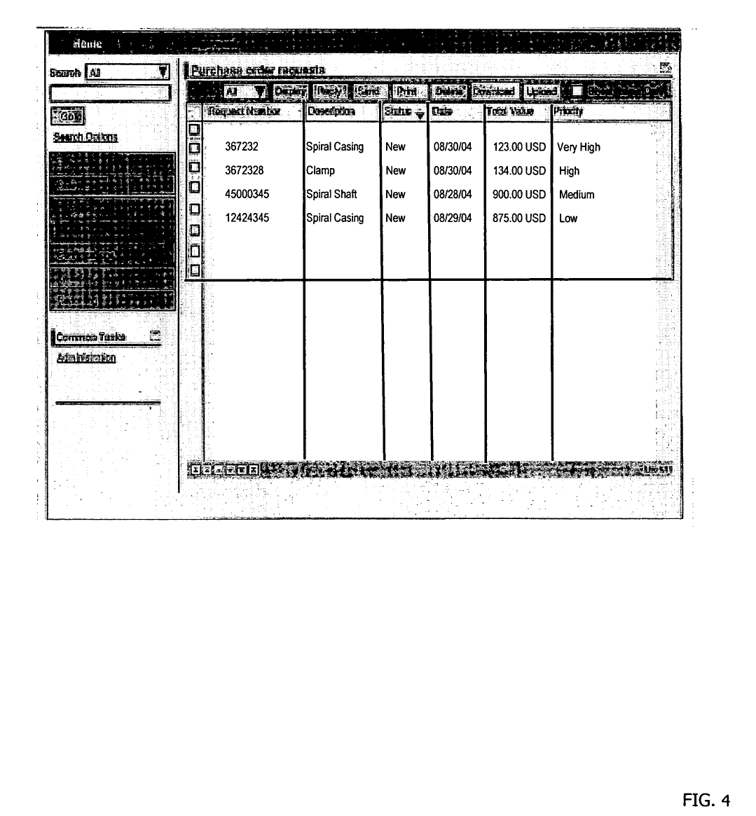

In an embodiment of the present invention, the list of queued P.O. requests 114 including determined priority data may be displayed in a table as shown in FIG. 4. The exemplary table shown in FIG. 4 includes a column labeled “Priority.” For each listed P.O. request 114, a corresponding cell in the “Priority” category indicates a priority category to which the P.O. request 114 has been assigned. Furthermore, the P.O. requests 114 may be displayed in the order of their determined priorities. In one example embodiment, a selectable option button may be provided to the user whereby the user may indicate whether the P.O. requests 114 should be displayed in the order of their priorities or in the order in which they were received.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A queue management method, comprising:
receiving an entry of a task to be, at least in part, manually performed;
automatically determining a priority category based on data associated with the entry;
automatically assigning the entry to the priority category; and
outputting data indicating the priority category to which the entry has been assigned.

2. The method of claim 1, wherein the entry is a purchase order (P.O.) request and the task is at least one of generation and transmittal of a P.O.

3. The method of claim 2, wherein the P.O. request includes an electronic document and the data on which the determination of the priority category is based is entered by a user into data fields of the electronic document.

4. The method of claim 1, wherein the data on which the determination of the priority category is based includes at least one of: at least one of a future delivery date and a future delivery time associated with the entry, an estimated lead time for delivery of at least one of a requested product and a requested service associated with the entry, and at least one of a current date and a current time.

5. The method of claim 4, wherein the priority category is determined based on a result obtained by applying a formula that is:
result=the at least one of the future delivery date and the future deliver time−the at least one of the current date and the current time−the estimated lead time.

6. The method of claim 5, wherein each of a plurality of results intervals is assigned to a corresponding one of a plurality of priority categories, the method further comprising:
determining in which of the results intervals the obtained result lies, wherein the priority category to which the determined results interval is assigned is one of (a) the priority category to which the entry is assigned and (b) used as a factor for determining the priority category to which the entry is assigned.

7. The method of claim 6, wherein the plurality of priority categories includes a low priority category, a medium priority category, and a high priority category.

8. The method of claim 6, wherein the formula is applied separately for each requested product and each requested service associated with the entry, the method further comprising:
if, by the separate application of the formula for each requested product and each requested service, a plurality of results intervals is determined, determining a highest one of the priority categories to which any of the determined plurality of results intervals is assigned, wherein the highest priority category is the priority category to which the entry is assigned.

9. The method of claim 6, wherein for each requested product and each requested service associated with the entry:
a corresponding priority category is determined; and
the output data indicates its corresponding priority category.

10. The method of claim 5, further comprising:
comparing the result with another result obtained by applying the formula to another entry, wherein the comparison is used for the determining of the priority category.

11. The method of claim 4, wherein the estimated lead time is determined based on a lead time history.

12. The method of claim 11, further comprising:
recording the determined estimated lead time;
determining a current actual lead time;
incrementing a number that reflects times a formula is applied for updating the estimated lead time; and
updating the estimated lead time by applying the formula;
wherein the formula is:
estimated lead time=((the recorded estimated lead time*(the number−1))+the determined current actual lead time)/the number.

13. The method of claim 4, wherein the entry is assigned to a different priority category if override instructions are received.

14. The method of claim 1, wherein the output data includes a list of tasks to be performed, the list including the task, the task's position in the list being in accordance with the priority category to which the task is assigned.

15. The method of claim 1, further comprising:
displaying a table including in each of a plurality of cells of a first column an identification of a corresponding one of a plurality of tasks to be performed, including the task of the received entry, wherein an identification of the priority category to which the task of the received entry is assigned is displayed in a cell of a second column, the cell of the second column being associated with the cell of the first column in which the identification of the task of the received entry is displayed.

16. The method of claim 1, further comprising:
determining the priority category based on a plurality of factors that are each assigned a respective weight.

17. The method of claim 16, wherein at least one of the weights is set by a user.

18. A computer-readable medium having stored thereon instructions adapted to be executed by a processor, the instructions which, when executed, cause the processor to perform the method of claim 1.

19. A procurement management method, comprising:
receiving a plurality of purchase order (P.O.) requests;
searching each of the P.O. requests for predetermined data elements;
based on the predetermined data elements, automatically assigning each of one or more of the P.O. requests to a corresponding priority category; and
displaying the P.O. requests and, for each of the one or more P.O. requests, the P.O. request's corresponding priority category.

20. A workflow management method, comprising:
upon receipt of a new task, assigning a priority category to the task based upon a due date of the new task;
queuing the new task with other previously prioritized tasks according to its priority category; and
thereafter, presenting the queued tasks to a task owner in priority order.
